(19) United States
(12) Patent Application Publication
(10) Pub. No.: US 2023/0209375 A1
(43) Pub. Date: Jun. 29, 2023

(54) SYSTEM AND METHOD FOR BEAM FAILURE RECOVERY

(71) Applicant: ZTE CORPORATION, Shenzhen (CN)

(72) Inventors: Shujuan ZHANG, Shenzhen (CN); Zhaohua LU, Shenzhen (CN); Chuangxin JIANG, Shenzhen (CN); Hao WU, Shenzhen (CN); Bo GAO, Shenzhen (CN); Huahua XIAO, Shenzhen (CN)

(73) Assignee: ZTE CORPORATION, Shenzhen (CN)

(21) Appl. No.: 18/178,202

(22) Filed: Mar. 3, 2023

Related U.S. Application Data
(63) Continuation of application No. PCT/CN2020/121156, filed on Oct. 15, 2020.

(51) Int. Cl. H04W 24/04; H04W 72/044

(52) U.S. Cl. CPC H04W 24/04; H04W 72/046

(57) ABSTRACT

A system and method for wireless communication are disclosed herein. In one embodiment, a method performed by a wireless communication device includes determining an occurrence of a beam failure based on monitoring a detecting reference signal resource set, and selecting a candidate reference signal resource from a candidate reference signal resource set, where the candidate reference signal resource set corresponds to the detecting reference signal resource set. In another embodiment, a method performed by a wireless communication device includes determining an occurrence of a beam failure based on monitoring a detecting reference signal resource set, selecting a candidate reference signal resource from a candidate reference signal resource set, and determining, according to the selected candidate reference signal resource, a parameter associated with a set of channels.

### CROSS-REFERENCE TO RELATED APPLICATION

This application claims the benefit of priority under 35 U.S.C. § 120 as a continuation of PCT Patent Application No. PCT/CN2020/121156, filed on Oct. 15, 2020, the disclosure of which is incorporated herein by reference in its entirety.

### TECHNICAL FIELD

The disclosure relates generally to wireless communications and, more particularly, to systems and methods for beam failure recovery.

### BACKGROUND

Wireless communication service covers more and more applications. Efficient measurement and reporting of cells associated with various wireless communication devices increasingly important. However, conventional systems may not be able to perform beam failure recovery associated with various wireless communication devices with conventional reference signaling. Thus, a technological solution for beam failure recovery is desired.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In one embodiment, a method performed by a wireless communication device includes determining an occurrence of a beam failure based on monitoring a detecting reference signal resource set, and selecting a candidate reference signal resource from a candidate reference signal resource set, where the candidate reference signal resource set corresponds to the detecting reference signal resource set.

In another embodiment, a method performed by a wireless communication device includes determining an occurrence of a beam failure based on monitoring a detecting reference signal resource set, selecting a candidate reference signal resource from a candidate reference signal resource set, and determining, according to the selected candidate reference signal resource, a parameter associated with a set of channels.

In another embodiment, a method performed by a wireless communication device includes determining an occurrence of a beam failure based on monitoring a detecting reference signal resource set, and reporting a beam failure index, where the beam failure index corresponds to at least one of the detecting reference signal resource set, a candidate reference signal resource set, a selected candidate reference signal resource, a serving cell index, or a signaling.

In another embodiment, a method performed by a wireless communication device includes determining an occurrence of a beam failure based on monitoring a detecting reference signal resource set, and selecting a candidate reference signal resource from a candidate reference signal resource set, where the candidate reference signal resource set includes a quasi-co-located reference signal of a CORESET.

In another embodiment, a method performed by a wireless communication device includes determining an occurrence of a beam failure based on monitoring a detecting reference signal resource set, and selecting a candidate reference signal resource from a candidate reference signal resource set, where the candidate reference signal resource set includes a plurality of groups.

In another embodiment, a method performed by a wireless communication device includes determining an occurrence of a beam failure based on monitoring a detecting reference signal resource set, selecting a candidate reference signal resource from a candidate reference signal resource set, and determining a Physical Cell Index (PCI) of the selected candidate reference signal resource.

In another embodiment, a method performed by a wireless communication device includes determining a beam failure index of a beam failure parameter, and initiating a beam failure recovery process according to the beam failure index.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader’s understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIG. 3 illustrates an example system for beam failure recovery including each of multiple PUCCH resource set corresponding to a candidate reference signal resource set respectively, in accordance with some embodiments of the present disclosure.

FIG. 4 illustrates an example system for beam failure recovery including a subset of PUCCH resource of a BWP corresponding to a candidate reference signal resource set, in accordance with some embodiments of the present disclosure.

FIG. 5 illustrates an example system for beam failure recovery including each of multiple PUCCH resource set corresponding to a BFR PRACH which has corresponding to a candidate reference signal resource set, in accordance with some embodiments of the present disclosure.

FIG. 6 illustrates an example system for beam failure recovery including each of multiple BFR CORESETs for a BWP corresponding to a candidate reference signal resource set, in accordance with some embodiments of the present disclosure.

FIG. 7 illustrates an example system for beam failure recovery including only one beam failure index in a BFR MAC-CE, in accordance with some embodiments of the present disclosure.

FIG. 8 illustrates a first example system for beam failure recovery including a beam failure index for each beam failure serving cell, in accordance with some embodiments of the present disclosure.

FIG. 9 illustrates a first example system for beam failure recovery including multiple beam failure indices for each beam failure serving cell, in accordance with some embodiments of the present disclosure.

FIG. 10 illustrates a second example system for beam failure recovery including including multiple beam failure indices for each beam failure serving cell, in accordance with some embodiments of the present disclosure.

FIG. 11 illustrates a second example system for beam failure recovery including a beam failure index for a beam failure parameter , in accordance with some embodiments of the present disclosure.

FIG. 12 illustrates a first example system for beam failure recovery including a candidate reference signal resource set including QCL-RS of a CORESET, in accordance with some embodiments of the present disclosure.

FIG. 13 illustrates a second example system for beam failure recovery including a candidate reference signal resource set including QCL-RS of a CORESET, in accordance with some embodiments of the present disclosure.

FIG. 14 illustrates a first example method for beam failure recovery process, in accordance with some embodiments of the present disclosure.

FIG. 15 illustrates an example method for beam failure recovery whose a candidate reference signal resource set with multiple groups, in accordance with some embodiments of the present disclosure.

### DETAILED DESCRIPTION OF EXAMPLE EMBODIMENTS

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be rearranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

Under New Radio (NR), beam failure recovery is introduced to deal with the blockage of beam transmission. In some implementations, beam failure recovery is for a serving cell. In some implementations, only once all the beam of the serving cell fails, the UE will trigger the beam failure recovery process. In some implementations, beam failure recovery is triggered when all beams of the serving cell fail. In some implementations, the gNB may not recover the beam quickly and successfully when the gNB fails to receive the new beam that the UE reports, or when the UE fails to select a new beam. Thus, it is advantageous to recover the beam quickly and easily. In some implementations, multi-TRP with non-ideal backhaul both transmit signal with the UE in a serving cell. In some implementations, if the gNB tracks which TRP fails in time, the gNB can recovery the fail TRP using another non fail TRP.

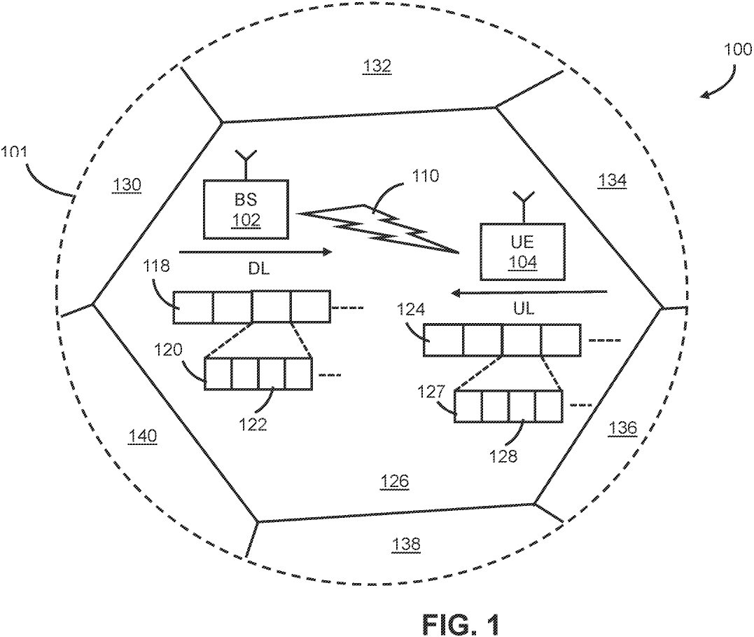

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

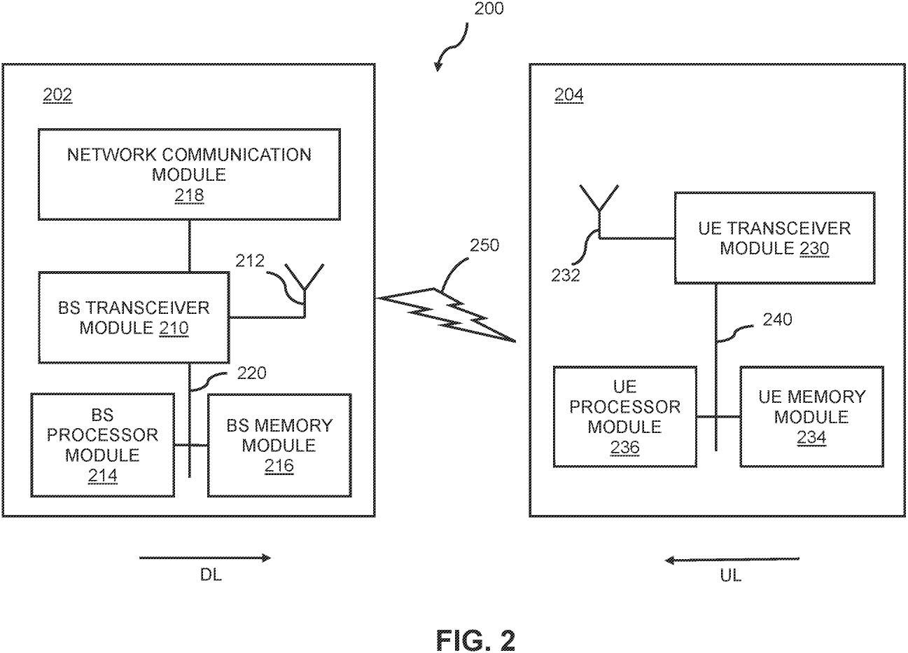

FIG. 2 illustrates a block diagram of an example wireless communication system 200 for transmitting and receiving wireless communication signals, e.g., OFDM/OFDMA signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

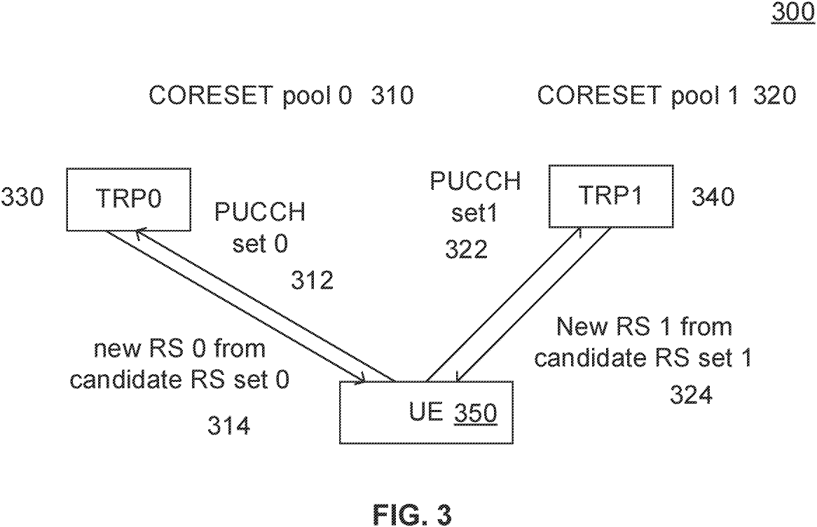

FIG. 3 illustrates an example system for beam failure recovery including each of multiple PUCCH resource set corresponding to a candidate reference signal resource set respectively, in accordance with some embodiments of the present disclosure. As illustrated by way of example in FIG. 3, example system 300 includes CORESET pool 0 310, PUCCH set 0 312, new RS 0 314, CORESET pool 1 320, PUCCH set 1 322, new RS 1 324, TRP0 330, TRP1 340 and UE 350.

In some implementations, the UE determines a corresponding relationship between a PUCCH resource and the new selected RS resource. In some implementations, the UE transmits the PUCCH using a parameter according to the new selected RS resource which has a corresponding relationship with the PUCCH resource. For example, the transmitting spatial domain filter of the PUCCH resource is the receiving spatial domain filter of the new selected RS resource.

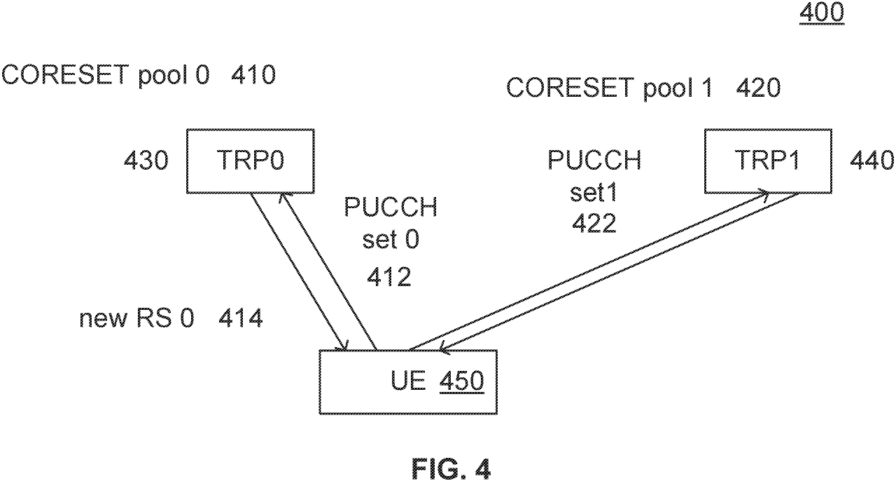

In some implementations, the UE determines the corresponding relationship according to the corresponding relationship between candidate RS resource set and the PUCCH resource. For example, the gNB configures two candidate RS resource sets for a BWP, where each candidate RS set corresponds to a TRP. In some implementations, the UE determines a candidate RS set i corresponding to PUCCH resource set i, wherein i=0,1. In some implementations, the UE transmits the PUCCH in the PUCCH resource set i using the new selected RS resource from the candidate RS resource set i after the UE receives a response from the gNB and after the UE reports the new selected RS resource as shown in FIGS. 3 and 4. In FIG. 3, there are two beam failure recovery processes each of which is for one TRP.

FIG. 4 illustrates an example system for beam failure recovery including a subset of PUCCH resource of a BWP corresponding to a candidate reference signal resource set, in accordance with some embodiments of the present disclosure. As illustrated by way of example in FIG. 4, example system 400 includes CORESET pool 0 410, PUCCH set 0 412, new RS 0 414, CORESET pool 1 420, PUCCH set 1 422, TRP0 430, TRP1 440 and UE 450.

By way of example, there is only one beam failure recovery processes for one TRP in FIG. 4. In some implementations, the parameter of a PUCCH resource in the PUCCH resource set 1 is not be changed according to the new RS resource 0 selected from candidate RS resource set 0. In some implementations, when one beam failure recovery process is for one TRP, only the parameter of the PUCCH resource corresponding to the one TRP will be got according to the selected new RS resource of the TRP. In some implementations, the parameter of the other PUCCH resource corresponding to another TRP is not got according to the new RS resource. In some implementations, the two PUCCH resource sets is in a same BWP.

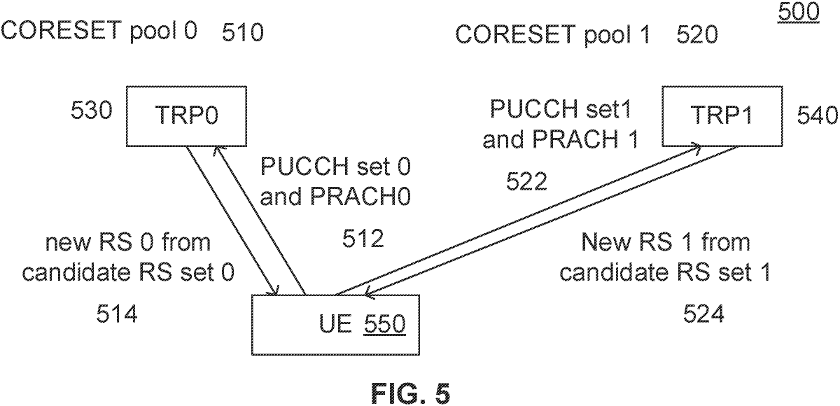

FIG. 5 illustrates an example system for beam failure recovery including each of multiple PUCCH resource set corresponding to a BFR PRACH which has corresponding to a candidate reference signal resource set, in accordance with some embodiments of the present disclosure. As illustrated by way of example in FIG. 5, example system 500 includes CORESET pool 0 510, PUCCH set 0 and PRACH 0 512, new RS 0 514, CORESET pool 1 520, PUCCH set 1 and PRACH 1 522, new RS 1 524, TRP0 530, TRP1 540 and UE 550.

Similarly, in some implementations, the parameter of the PUCCH resource got according to the selected RS resource corresponding to the PUCCH resource or corresponding to the PUCCH resource set including the PUCCH resource, includes at least one of: the power parameter of the PUCCH resource and the transmitting spatial domain filter. Similarly, in some implementations, the UE determines a corresponding relationship between a PUCCH resource and a channel corresponding to the new selected RS resource as shown in FIG. 5. In some implementations, the UE transmits the PUCCH using a parameter according to the parameter of the channel which has a corresponding relationship with the PUCCH resource. For example, the transmitting spatial domain filter of the PUCCH resource is the transmitting spatial domain filter of the channel. In some implementations, the channel is a PRACH whose preamble has a corresponding relationship with the new selected RS resource. In some implementations, the channel is also a PUSCH including information for reporting of the new selected RS resource. In some implementations, the parameter of a PUCCH resource in PUCCH resource set i is got according to the PRACH i as shown in by way of example in FIG. 5.

In some implementation, the UE determines a relationship between a PUCCH resource and a candidate RS resource when they are associated with a common index. In some implementations, a common index includes a CORESET pool index, detecting an RS resource set index among multiple detecting RS set of one BWP, or other index associated with a beam failure parameter. In some implementations, the index corresponds to a beam failure index. The beam failure parameter includes at least one of detecting an RS resource set, a candidate RS resource set, a mapping between candidate RS resources and PRACH resource, a search space set for beam failure, a parameter of PRACH resource used for beam failure request, an RSRP threshold, a beam failure recovery timer, a beam failure detection timer, the maximum number of instance counter, a PUCCH resource set whose parameter is received according to the new selected RS resource, a CORESET pool whose parameter is received according to the new selected RS resource, a PDSCH, and an SPS-PDSCH.

In some implementations, the CORESET pool index associated with a PUCCH resource scheduled by a PDCCH is the CORESET pool index of the CORESET including the PDCCH. In some implementations, the CORESET pool index associated with a PUCCH resource without a PDCCH is determined to be default value, such as 0, or is determined by configuration. For example, the gNB configures a PUCCH resource group with a CORESET pool index. For example, the gNB configures a period or semi-period PUCCH resource with a CORESET pool index In some implementations, the beam failure index associated with the new selected RS resource is the beam failure index associated with the candidate RS resource set including the new selected RS resource.

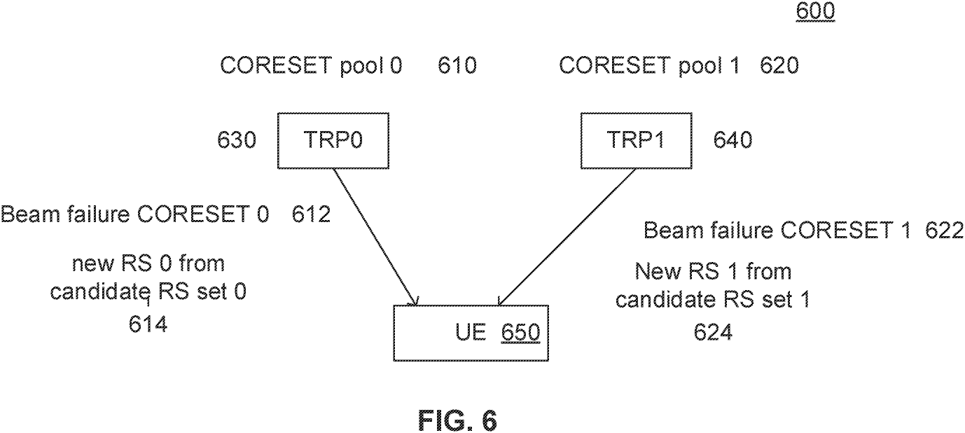

FIG. 6 illustrates an example system for beam failure recovery including each of multiple BFR CORESET for a BWP corresponding to a candidate reference signal resource set, in accordance with some embodiments of the present disclosure. As illustrated by way of example in FIG. 6, example system 600 includes CORESET pool 0 610, beam failure CORESET 0 612, new RS 0 614, CORESET pool 1 620, beam failure CORESET 1 622, new RS 1 624, TRP0 630, TRP1 640 and UE 650.

In some implementations, the UE determines a corresponding relationship between CORESET and a new selected RS resource. In some implementations, the QCL-RS of the CORESET is the new selected RS resource which has corresponding relationship with the CORESET. In some implementations, the UE determines a relationship between the CORESET and the new selected RS resource when they are associated with the same beam failure index. For example, the QCL-RS of CORESET in the CORESET pool i is the new selected RS from candidate reference signal resource set i as shown by way of examples in FIGS. 3-6. In some implementations, the two CORESET pools are in a common BWP.

In some implementations, the gNB configures two beam failure CORESETs each of which is only associated with one beam failure recovery search space set. In some implementations, the QCL-RS of beam failure CORESET associated with beam failure index i is the new selected RS from candidate reference signal resource set i as shown in FIG. 6 where i=0,1. In some implementations, the gNB configures two beam failure search space sets. In some implementations, the QCL-RS of beam failure search space set i is the new selected RS candidate reference signal resource set i. If the two beam failure search space sets are associated with the same CORESET, the QCL-RS of the CORESET only to be one selected RS resource (i.e one selected RS resource) when the two search space sets overlaps in time domain, or overlap in the time domain and a frequency domain. If the two beam failure search space sets are associated with the same CORESET, only the QCL-RS of the CORESET with the same beam failure index of the selected candidate reference signal resource is determined to be the select candidate reference signal resource. The UE determining the beam failure index of two QCL-RS of the CORESET.

In some implementations, the number of selected candidate reference signal resources is not equal to the number of QCL-RS or TCI state of the CORESET. In some implementations, if the number of selected candidate reference signal resource is larger than the number of QCL-RS or TCI state of the CORESET, the UE selectes a beam failure index from multiple beam failure indices. Then, the QCL-RS of the CORESET is the selected candidate RS resource with the selected beam failure index. In some implementations, if the number of selected candidate reference signal resources equals or is smaller than the number of QCL-RS or TCI state of the CORESET, the UE determines a beam failure index for the multiple QCL-RS or the TCI state of the CORESET, the QCL-RS associated with a beam failure index of the CORESET will be the selected candidate RS resource with the same beam failure index as the QCL-RS or TCI states. Some of the QCL-RS or the TCI state of the CORESET may be not changed. When the QCL-RS of PDSCH is got according to a selected reference signal resource and the number of the QCL-RS(or TCI state) and the number of selected candidate reference signal resource is not same, above method can be similarly used. When the QCL-RS of PDSCH is got according to a selected reference signal resource and the number of the QCL-RS(or TCI state) is more than one, the UE needs to determining a beam failure index of the QCL-RS(or TCI state) of PDSCH. The QCL-RS(or TCI state) is got according to a selected candidate reference signal resource with same beam failure index of TCI state. Similarly, the number of selected candidate reference signal resources is not equal to the number of transmitting filter of a PUCCH/PUSCH, or one of the numbers is more than one, above method can be similarly used.

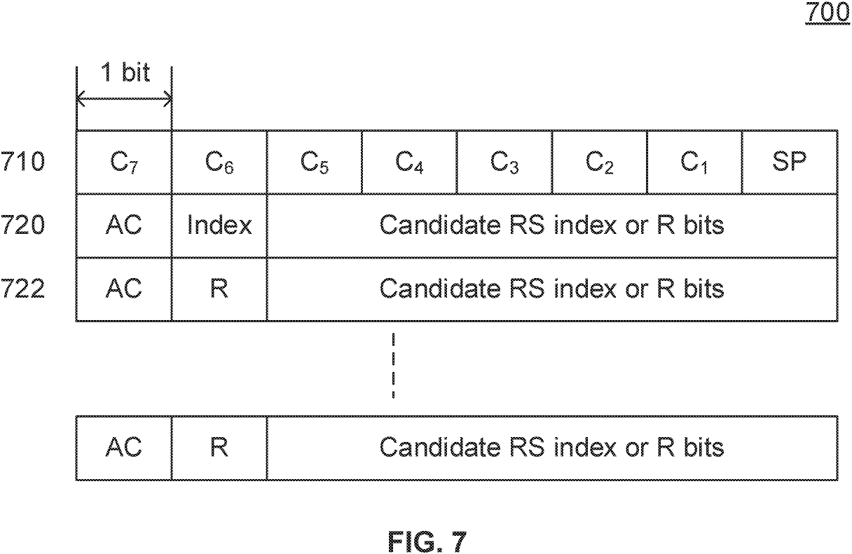

FIG. 7 illustrates an example system for beam failure recovery including only one beam failure index in a BFR MAC-CE, in accordance with some embodiments of the present disclosure. As illustrated by way of example in FIG. 7, example system 700 includes Cj bits 710, AC index bits 720 and AC R bits 722.

In some implementations, the UE determines a beam failure index of a BFR MAC-CE. In some implementations, one BFR MAC-CE is with only one beam failure index. In some implementations, the UE reports the beam failure index in the BFR MAC-CE as shown by way of example in FIG. 7. In some implementations, the information in the MAC-CE is associated with the same beam failure index. In some implementations, the information associated with different beam failure indices is in different MAC-CE. In some implementations, the Cⱼ corresponds to the severing cell j to indicate whether beam failure is detected for the severing cell j based on detecting RS resource set associated with the beam failure index in the MAC-CE. In some implementations, an SP bit corresponds to the Special cell (such as primary cell, primary second cell) to indicate whether beam failure is detected for the severing cell j based on detecting RS resource set associated with the beam index in the MAC-CE. In some implementations, a candidate RS index corresponds to the new selected RS resource from a candidate RS resource set associated with the beam failure index in the MAC-CE. In some implementations, AC indicates whether there is a new selected RS resource with quality higher than a threshold in the candidate RS resource for one beam failure serving cell. In some implementations, the quality of the new selected RS resource is higher than a threshold. In some implementations, AC indicates whether there is a new selected RS resource with quality higher than a threshold in the candidate RS resource set associated with a beam failure index for one beam failure serving cell. If one serving cell isn’t configure beam failure for beam failure parameter, the beam failure index of the beam failure parameter is a default value, for example 0.

In some implementations, the beam failure index of the MAC-CE is also not in the MAC-CE. In some implementations, the UE determines the beam failure index of the MAC-CE according to a beam failure index associated with the PUSCH including the MAC-CE. In some implementations, the two MAC-CEs with different beam failure index are in different PUSCH associated with different beam failure index. For example a MAC-CE should be in PUSCH associated with the same beam failure index as with the MAC-CE, the beam failure index of a PUSCH is the beam failure index associated with a CORESET including a PDCCH scheduling the PUSCH. For a PUSCH without PDCCH, the beam failure index can be configured.

In some implementations, the number of the octet including AC and candidate RS resource is the number of Cⱼ with indication 1. In another implementation, the number of the octet including AC and candidate RS resource is the sum of the number of Cⱼ with indication 1 and 1 when the SP field is 1. In some implementations, the number of the octet including AC and candidate RS resource is the number of Cⱼ with indication 1 when the SP field is 0.

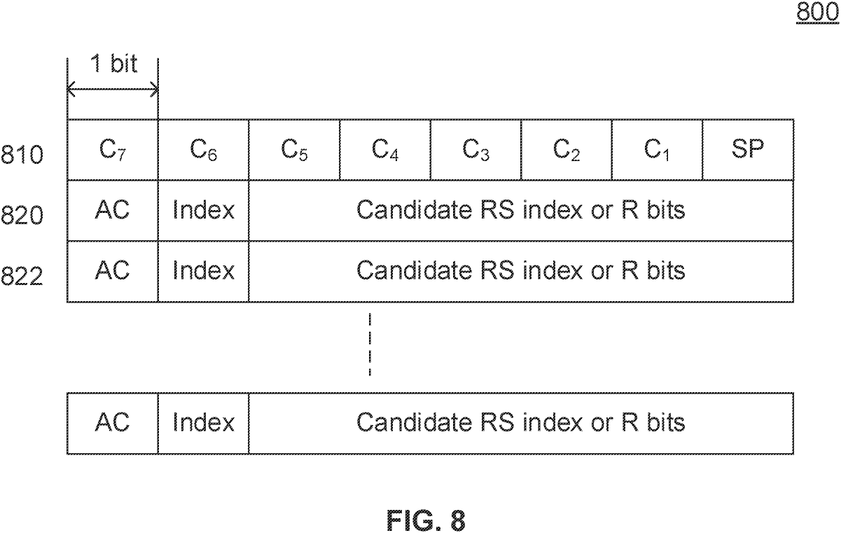

FIG. 8 illustrates a first example system for beam failure recovery including a beam failure index for each beam failure serving cell, in accordance with some embodiments of the present disclosure. As illustrated by way of example in FIG. 8, example system 800 includes Cj bits 810, and AC index bits 820 and 822.

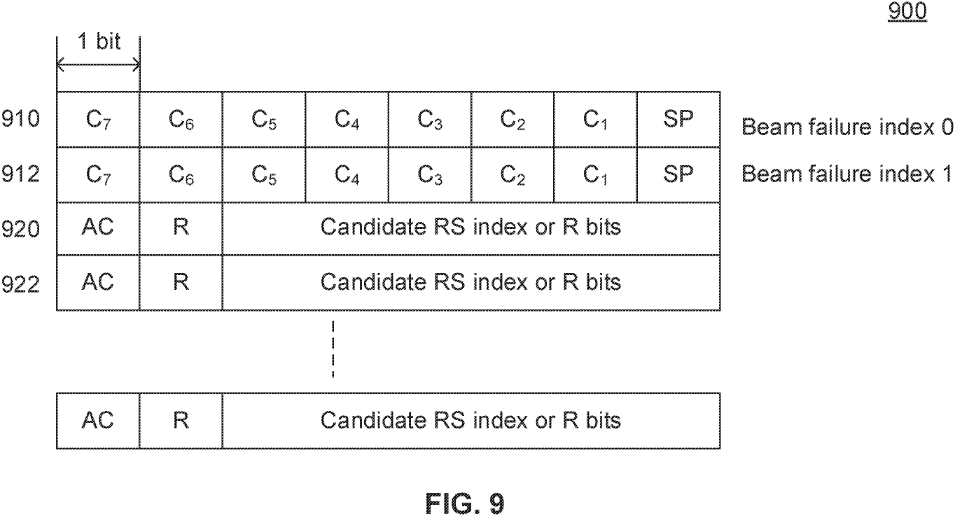

In some implementations, the UE determines a beam failure index of each new selected candidate RS resource and/or each serving cell as shown in FIGS. 8 and 9. In FIG. 8, there is only one beam failure index for each beam failure serving cell in one BFR MAC-CE. Thus, in some implementations, the UE can only report one octet including one AC, or including one AC and one new RS resource index for one beam failure process of one serving cell in one BFR MAC-CE. In some implementations, the octets containing the AC field are present in ascending order based on the Cj with 1. In some implementations, the number of the octets containing the AC field is the number of the Cⱼ with 1,j=1,..7. In some implementations, the highest beam failure serving cell index is less than 8. Thus, in some implementations, if the highest beam failure serving cell index is equal or larger than 8, the number of the octets containing Cⱼ is 4. In another implementation, the octets containing the AC field are present in ascending order based on the Cj and SP with 1, the serving cell index of SP is 0. In some implementations, the number of the octets containing the AC field is sum of the number of the Cⱼ with 1 and 1 when the SP field is 1,j=1,..7. In some implementations, the number of the octets containing the AC field is the number of the Cⱼ with 1 when the SP field is 0,j=1,..7.

FIG. 9 illustrates a first example system for beam failure recovery including multiple beam failure indices for each beam failure serving cell, in accordance with some embodiments of the present disclosure. As illustrated by way of example in FIG. 9, example system 900 includes Cj bits 910 and 912, and AC R bits 720 and 722.

As shown by way of example in FIG. 9, there are two octets containing bits for a same Cⱼ. In some implementations, the bit in the first octet is for beam failure index 0, and the bit in the second octet is for beam failure index 1.

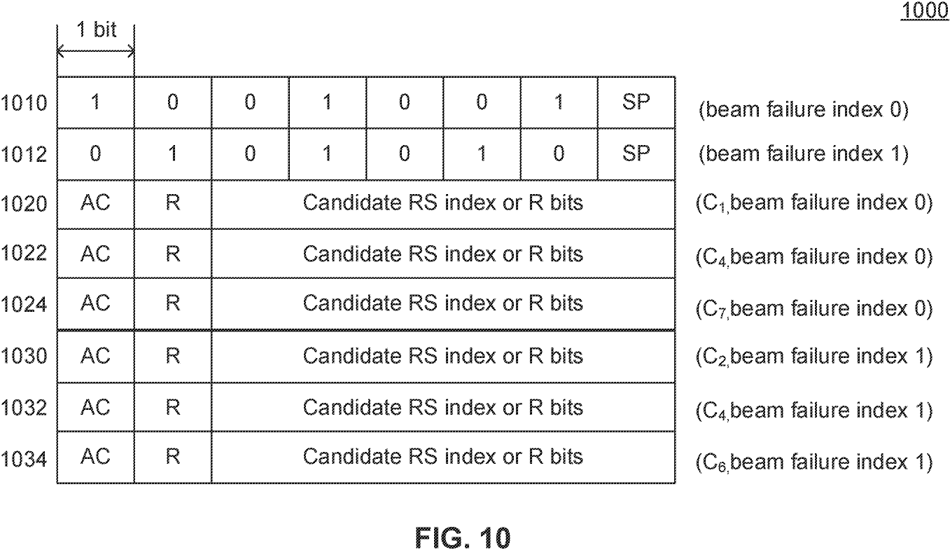

FIG. 10 illustrates a second example system for beam failure recovery including multiple beam failure indices for each beam failure serving cell, in accordance with some embodiments of the present disclosure. As illustrated by way of example in FIG. 10, example system 1000 includes Cj bits 1010 and 1012, and AC R bits 1020, 1022, 1024, 1030, 1032 and 1034.

In some implementations, the octets containing the AC field are present in ascending order based on the Cⱼ with 1 in the first octet containing Cⱼ and then in ascending order based on the Cⱼ with 1 in the second octet containing Cⱼ as shown by way of example in FIG. 10. For example, the bit for C₄ in the first octet indicates beam failure detection based on the detecting RS set associated with beam failure index 0 and the presence of an octet containing the AC field for the beam failure process 0 of SCell with ServCellIndex 4. In some implementations, the bit for C₄ in the second octet indicates beam failure detection based on the detecting RS set associated with beam failure index 1 and the presence of an octet containing the AC field for the beam failure process 1 of SCell with ServCellIndex 4. In some implementations, the number of the octets containing the AC field is the number of the Cⱼ with 1 in the two octets contain Cⱼ ,j=1,..7. In some implementations, the highest beam failure serving cell index is less than 8. Thus, in some implementations, if the highest beam failure serving cell index is equal or larger than 8, the number of the octets containing Cⱼ is 8 ,wherein the first four octets is for beam failure index 0 and the second four octets is for beam failure index 1. In another implementation, the octets containing the AC field are present in ascending order based on the Cⱼ with 1 and SP with 1 in the first octet containing Cⱼ and then in ascending order based on the Cⱼ with 1 and SP with 1 in the second octet containing Cⱼ. In a third implementation, the octets containing the AC field are present in ascending order based on the Cⱼ with 1 in the first octet containing Cⱼ and then in ascending order based on the Cⱼ with 1 in the second octet containing Cⱼ then one octet for a SP with 1.

In some implementations, the gNB configures a MeasObjectID without configuring a candidate reference signal resource index. For example, the candidate RS resource set is {RS 1,RS2,MeasObjectID 1}. In some implementations, when beam failure is detected, the UE selects a new RS resource from the RS resource set. In some implementations, if the UE selects MeasObjectID 1 when the quality of RS1 and RS2 are both below a threshold, the UE reports the selected PCI of the MeasObjectID 1. Then, the UE reports the selected PCI of the MeasObjectID 1 and a selected reference signal resource index of the selected PCI of the MeasObjectID 1. In some implementations, the selected PCI and reference signal resource index of the selected PCI are in a BFR MAC-CE. Alternatively, in some implementations, the UE transmits a PRACH using parameter which has a corresponding relationship with the selected PCI and/or the selected reference signal resource index.

In some implementations, if a PCI associated with the selected new RS resource and the PCI associated with the detecting RS set are different, the start time for using the new RS resource for a channel is delayed. For example, the QCL-RS of a BFR-CORESET is the new RS resource starting from a slot which is later than slot n+4,for example slot n+5, where the UE transmits a PRACH triggered by the beam failure in slot n. In some implementations, the parameter of a PUCCH resource is based on the new selected RS resource after a more than 28 time domain symbols from a last symbol of a response of the BFR MAC-CE. In some implementations, the QCL-RS of a CORESET is based on the new selected RS resource after a number of time domain symbols which is more than 28 from a last of response of the BFR MAC-CE. In some implementations, the response of the BFR MAC-CE is a PDCCH with a DCI format scheduling a PUSCH transmission with a same HARQ process number as for the transmission of the PUSCH including the BFR MAC-CE, and having a toggled NDI field value.

Similarly, in some implementations, if a PCI associated with the selected new RS resource and a PCI associated with the CORESET/PUCCH resource/PDSCH before are different, the start time for using the new RS resource for the CORESET/PUCCH/PDSCH is delayed. In some implementations, the PCI associated with the CORESET is the PCI associated with QCL-RS of the CORESET before the beam failure. In some implementations, the PCI associated with the PUCCH resource is the PCI associated with spatial relationship RS of the PUCCH resource before the beam failure. In some implementations, the PCI associated with the PDSCH is the PCI associated with QCL-RS of PDSCH before the beam failure. Alternatively, in some implementations, the PCI associated with the PDSCH is the PCI associated with QCL-RS of CORESET scheduling the PDSCH before the beam failure.

In some implementations, for a serving cell, after a predefined number of symbols from a last symbol of the BFR MAC-CE, the UE monitors all the CORESET in the serving cell using the QCL-RS of the PDCCH in the CORESET as the selected new RS resource of the serving cell. In some implementations, every CORESET is associated with the same QCL-RS, i.e same beam. In some implementations, these CORESETs are then associated with the same CORESET pool index. For example, before beam failure,{CORESET 1,CORESET 4} are associated with CORESET pool index 0 and {CORESET 0,CORESET 2,CORESET 3} are associated with CORESET pool index 1. Before beam failure, these CORESTs can be associated with different QCL-RS. After beam failure, all of these CORESETs are associated with the same QCL-RS which is the new selected RS resource. In some implementations, these CORESETs are transmitted from a same TRP. Then, in some implementations, every CORESET in the serving cell is associated with the same CORESET pool. In some implementation, if the number of CORESET of the serving cell (or of a BWP of the serving cell) is larger than a threshold, the UE only monitoring some of the CORESETs using QCL-RS as the selected candidate beam failure reference signal resource. Some of the CORESETs of the serving cell (or of a BWP of the serving cell) is deactivated.

For example, the CORESETs in the serving cell are associated with the CORESET pool 0. In some implementations, the UE determines, according the CORESET pool index, at least one of a hybrid automatic repeat request ack (HARQ-ACK), a time domain relationship between two physical downlink channels (PDSCHs), a time domain relationship between two physical uplink shared channels (PUSCHs), and a time domain relationship between a HARQ-ACK with different PDSCHs. In this example, there are two CORESET pools in the serving cell, but the beam failure is for the serving cell not for per CORESET pool.

Similarly, in some implementations, for a BWP, after a predefined number of symbols from a last symbol of the BFR MAC-CE, the UE monitors every CORESET in the BWP using the QCL-RS of the PDCCH in the CORESET as the selected new RS resource of the serving cell. In some implementations, all of the CORESETs in the BWP are associated with the same QCL-RS. In some implementations, the same QCL-RS is the same beam. Then, these CORESETs in the BWP are associated with the same CORESET pool index.

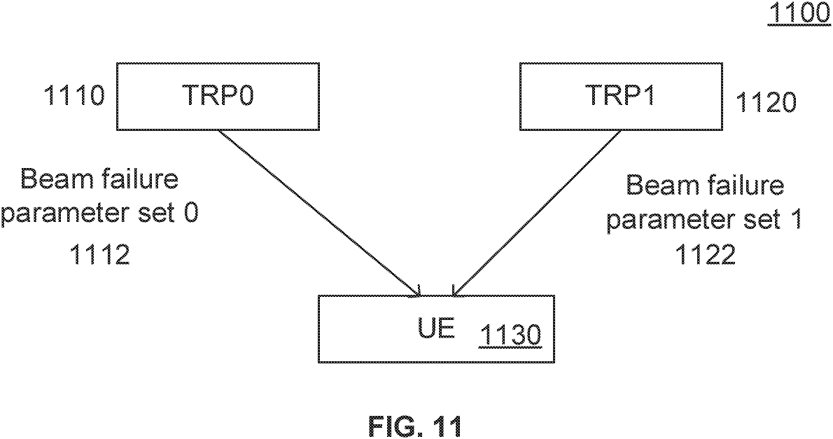

FIG. 11 illustrates a second example system for beam failure recovery including a beam failure index for a beam failure parameter , in accordance with some embodiments of the present disclosure. As illustrated by way of example in FIG. 11, example system 1100 includes TRP0 1110, beam failure parameter set 0 1112, TRP1 1120, beam failure parameter set 1 1122, and UE 1130.

In some implementations, there are two sets of beam failure parameters for one serving cell or for one BWP. In some implementations, each set of the beam failure parameters is associated with a beam failure index as shown by way of example in FIG. 11. In some implementations, two sets of beam failure parameters correspond to two independent beam failure processes for the serving cell or for the BWP.

In some implementation, there are two configurations for a same type of beam failure parameter for one BWP or for one serving cell. In some implementations, each configuration is associated with a beam failure index. In some implementations, the different type parameters associated with same beam failure index correspond to one beam failure process for one BWP or for one serving cell. In some implementations, the different configurations for a same type of beam failure parameter are associated with a different beam failure index corresponding to two beam failure processes for one BWP, or for one serving cell, respectively.

In some implementations, the beam failure parameter includes at least one of detecting RS resource set, a candidate RS resource set, a mapping between candidate RS resources and PRACH resource, a search space set for beam failure, a parameter of PRACH resource used for beam failure request, a RSRP threshold, a beam failure recovery timer, a beam failure detection timer; the maximum number of instance counter, a PUCCH resource set whose parameter will be got according to the new selected RS resource, a CORESET pool whose parameter will be got according to the new selected RS resource, a PDSCH, a SPS-PDSCH, a BFR search space set.or a QCL-RS(or TCI state) which is got based on a selected candidate reference signal resource.

When the serving cell is a Special serving cell, i.e Primary cell or Primary SCG (secondary cell group) cell, or the BWP is in a Special serving cell, the two beam failure parameter sets both include beam failure PRACH configuration. In some implementations, the two beam failure parameter sets correspond to two different beam failure processes. In some implementations, if beam failure is detected simultaneously for the two beam failure processes, the UE selects one candidate RS from the two candidate RS resource sets and transmits the PRACH using the PRACH resource associated with the selected candidate RS resource.

In another implementation, the two beam failure detecting reference signal resource sets correspond one beam failure PRACH configuration. In some implementations, there are three beam failure detecting processes. In some implementations, the first detecting RS resource set is associated with the first beam failure parameter set. In some implementations, the second detecting RS resource set is associated with the second beam failure parameter set. In some implementations, the third detecting RS resource set is the union set of the first detecting RS resource set and the second detecting RS resource set. In some implementations, when the UE detects beam failure based on the first detecting RS resource set or the second detecting RS resource set, the UE reports beam failure detection in MAC-CE. Alternatively, in some implementations, the UE reports beam failure detection and selected candidate RS resource index in MAC-CE. In some implementations, if the UE detects an RS resource based on the third detecting RS resource set, the UE transmits a PRACH using parameter corresponding to the selected RS resource index.

For example, the first detected RS resource set is {RS1, RS2} and the second detected RS resource set is {RS3,RS4}, and the third detected RS resource is RS1,RS2,RS3,RS4}. Thus, when the quality for all RS resources in the j detecting RS resource set, j=1,2,3, the UE records an instance for the detecting RS resource set j. If the UE detects beam failure based on the third detecting RS resource set, the UE transmits the PRACH using a parameter corresponding to the selected RS resource selected from a union set of the first candidate RS resource set and the second candidate RS resource set. If the UE detects beam failure based on the j detecting RS resource set,j=1 or 2, the UE reports the beam failure detection and candidate RS resource in the MAC-CE.

In some implementations, the beam failure PRACH configuration includes at least one of a mapping between candidate RS resources and PRACH resource, search space set for beam failure, a parameter of PRACH resource used for beam failure request, and an RSRP threshold.

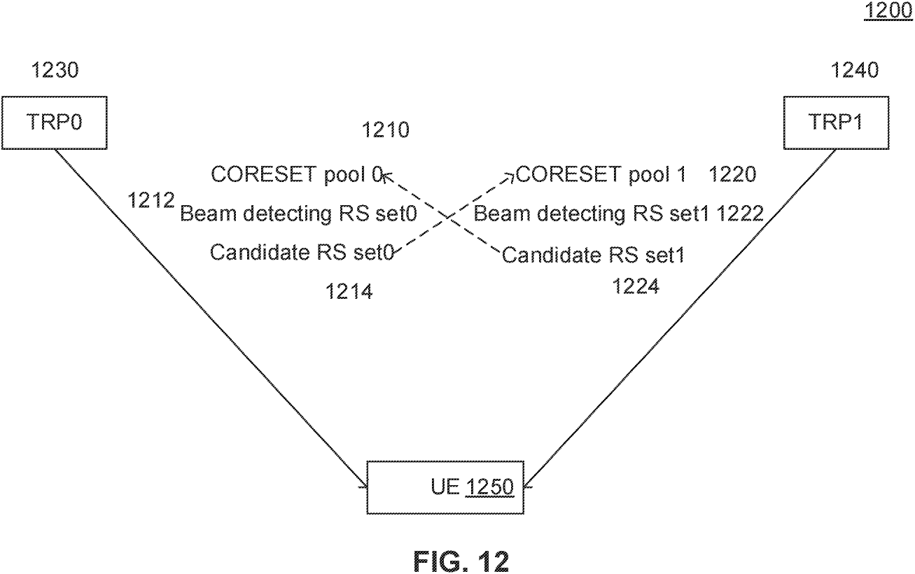

FIG. 12 illustrates a first example system for beam failure recovery including a candidate reference signal resource set including QCL-RS of a CORESET , in accordance with some embodiments of the present disclosure. As illustrated by way of example in FIG. 12, example system 1200 includes CORESET pool 0 1210, beam detecting RS set 0 1212, candidate RS set 0 1214, CORESET pool 1 1220, beam detecting RS set 1 1222, candidate RS set 1 1224, TRP0 1230, TRP1 1240 and UE 1250.

In some implementations, the candidate RS set includes an RS resource received according to QCL-RS of a CORESET. In some implementations, the QCL-RS of a CORESET means that the QCL-RS and DMRS of the CORESET is quasi co-located with respect to one or more large-scale properties of the channel. In some implementations, large-scale properties includes at least one of delay spread, Doppler spread, Doppler shift, average gain, average delay, and spatial Rx parameters. In some implementations, when the CORESET with two QCL-RSs with different QCL-type, the UE gets the QCL-RS with QCL-type D to be the candidate RS resource. In some implementations, the candidate RS set includes more than one candidate RS resource according to QCL-RSs of two different CORESETs with the same CORESETpoolindex.

In some implementations, the UE detects the quality of a detecting RS resource set to find whether beam failure occurs. In some implementations, when beam failure occurs, the UE selects a candidate RS resource (i.e a new RS resource) in the candidate RS resource set where the quality of the selected RS resource is higher than a threshold. In some implementations, the CORESET pool associated with the detecting RS set and the CORESET pool whose QCL-RS will be in the candidates RS set are different. In some implementations, the CORESET pool corresponding to a detecting RS set is the CORESET pool whose DMRS has QCL relationship with the RS resource in the detecting RS resource set. In some implementations, when one TRP fails, the UE selects the beam of the other TRP to recovery the CORESET of the one TRP.

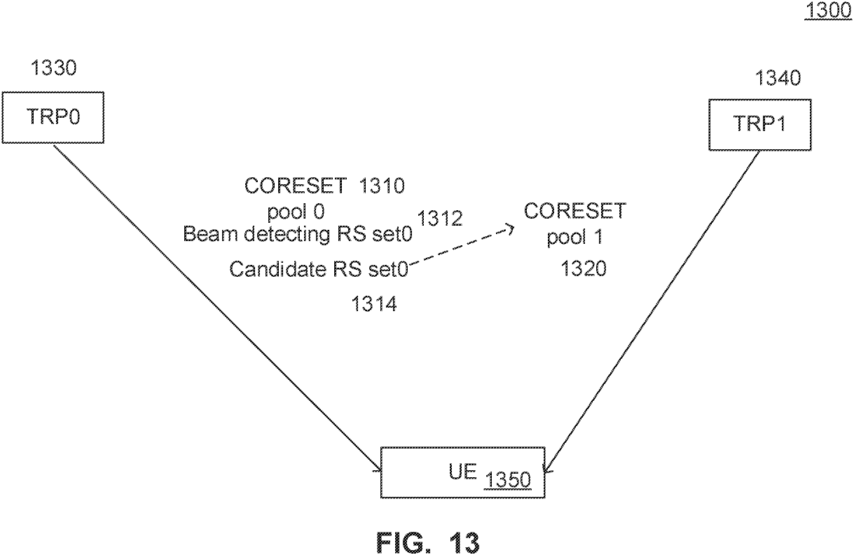

For example, the gNB configures two CORESET pools for a serving cell as shown by way of example in FIGS. 12 and 13. In some implementations, two CORESET pools have different CORESETpoolindex. In some implementations, each CORESET in a CORESET pool is with the same CORESETpoolindex. In some implementations, each CORESET pool corresponds to a TRP. In some implementations, one beam failure detects an RS set with one CORESETpoolindex. In some implementations, the UE processes independent beam failure recovery processes for each CORESET pool. In some implementations, there are two beam failure recovery processes in a BWP simultaneously. In some implementations, each CORESET pool is associated with a detecting RS resource set and a candidate RS set. In some implementations, the candidate RS set 0 includes QCL-RS of a CORESET in CORESETpoolindex 1. In some implementations, the candidate RS set 1 includes QCL-RS of a CORESET in CORESETpoolindex 0. In some implementations, when the UE detects beam failure based on detecting RS resource set 0, the UE selects the QCL-RS of a CORESET pool index 1 to be the new selected the RS resource and reports gNB the new selected RS resource index. In some implementations, if the UE selects the new RS from candidate RS set 0 including the QCL-RS for CORESET in CORESET pool 1, the CORESET of the CORESET pool 0 can be deactivated. Alternatively, in some implementations, the CORESET pool 0 is included in the CORESET pool 1, or the CORESET pool index of the beam failure CORESET should be 1.

FIG. 13 illustrates a second example system for beam failure recovery including a candidate reference signal resource set including QCL-RS of a CORESET, in accordance with some embodiments of the present disclosure. As illustrated by way of example in FIG. 13, example system 1300 includes CORESET pool 0 1310, beam detecting RS set 0 1312, candidate RS set 0 1314, CORESET pool 1 1320, TRP0 1330, TRP1 1340 and UE 1350.

In some implementations, the UE only detects CORESET pool 0, the detecting RS set and candidate RS resource set are both associated with CORESET pool 0, and the candidate RS includes QCL-RS of CORESET in CORESET pool index 1.

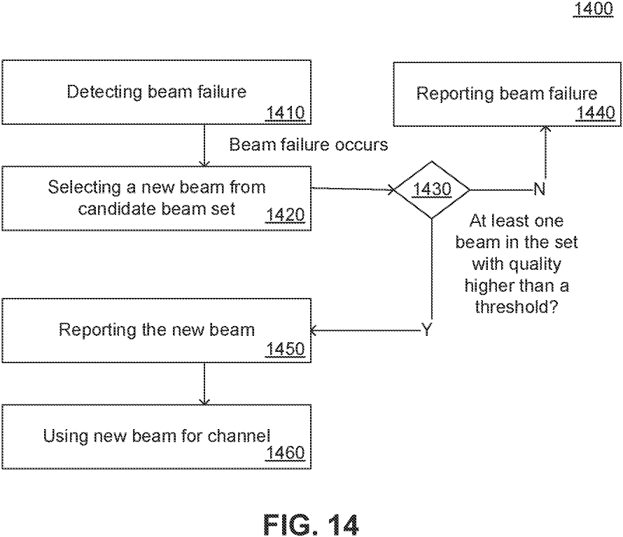

FIG. 14 illustrates a first example method for beam failure recovery process, in accordance with some embodiments of the present disclosure. As illustrated by way of example in FIG. 14, example method 1400 includes steps 1410, 1420, 1430, 1440, 1450 and 1460.

In some implementations, beam failure recovery includes, as shown in FIG. 14, detecting beam failure when the quality for all reference signal (RS) resources in a detecting RS resource set is lower than a threshold. In some implementations, the UE records one instance. In some implementations, beam failure occurs when the number of the instance with interval between two instances smaller than a threshold is equal to or larger than the predefined number. In some implementations, selecting a new beam from a candidate beam set (i.e a candidate RS resource set, a RS resource can corresponds to a beam) when beam failure occurs. In some implementations, reporting the new beam when at least one beam is in the candidate beam set with quality higher than a threshold. In some implementations, using a new beam for a channel after reporting the selected candidate beam (i.e the selected candidate reference signal resource). For example, the UE can receive PDSCH and/or PDCCH using the new beam. In some implementations, the DMRS of the PDSCH and/or the PDCCH is QCL-ed (quasi co-location) with the RS associated with the new beam. In some implementations, the UE also transmits the PUCCH according to the new beam. For example the spatial domain filter and/or power parameter of the PUCCH is received based on the receiving spatial domain filter of the new beam.

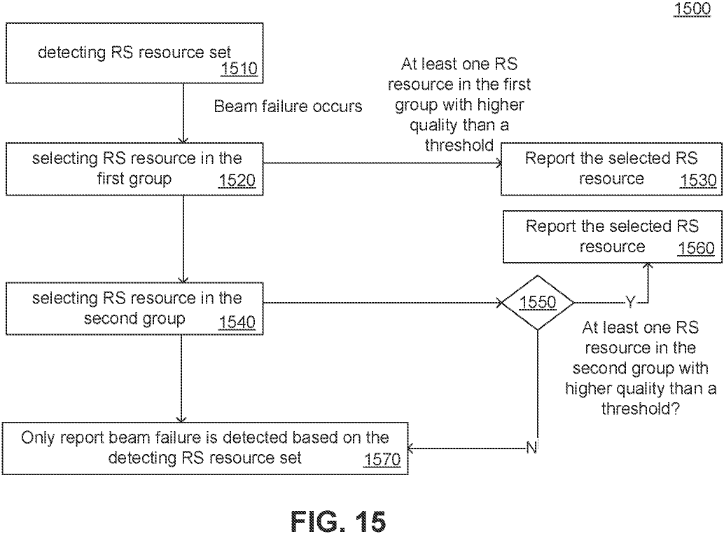

FIG. 15 illustrates an example method for beam failure recovery whose candidate reference signal resource set with multiple groups, in accordance with some embodiments of the present disclosure. As illustrated by way of example in FIG. 15, example method 1500 includes steps 1510, 1520, 1503, 1504, 1550, 1560 and 1570.

In some implementations, one Candidate RS resource set has two RS resource groups. In some implementations, when UE detects that beam failure occurs based on the detecting RS resource set corresponding to the Candidate RS resource set, the UE first selects an RS resource in a first RS resource group. If there is no RS resource in the first resource group with higher quality than a threshold, the UE then selects an RS resource in the second RS group.

In some implementations, two candidate RS resource sets are also named two candidate RS resource sets, and one detecting RS resource set are thus associated with two candidates RS resource sets. In some implementations, the first candidate RS resource group is configured by gNB. In some implementations, the second candidate RS resource group is got according to QCL-RS of CORESET. In some implementations, the second candidate RS resource group is got according to QCL-RS of one or more CORESETs with the same CORESET pool index. In some implementations, the two candidate RS resource groups correspond to different PCI (physical cell index). The first group corresponds to a first PCI and the second group corresponds to a second PCI. The second PCI may correspond to a neighboring cell.

In some implementations, the UE is configured with two BFR (beam failure recovery) search space sets for a serving cell; for example, a special serving cell. In some implementations, after the UE transmits PRACH corresponding to a candidate reference signal resource, the UE monitors PDCCH in the BFR in a BFR search space set with the same beam failure index as the candidate reference signal resource. In some implementations, the UE considers the PRACH successfully completed when the UE monitors a PDCCH with C-RNTI in the BFR search space set with the same beam failure index same as the candidate reference signal resource. A beam failure index of a candidate reference signal resource is the beam failure index of the candidate reference signal resource set.

In some implementations, the UE monitors PDCCH in the BFR search space until the UE receives by higher layers an activation for a TCI state associated with the same beam failure index as the selected candidate reference signal resource or any of the parameters tci-StatesPDCCH-ToAddList and/or tci-StatesPDCCH-ToReleaseListwith the same beam failure index as the selected candidate reference signal resource.

In some implementations, for the PCell or the PSCell, after 28 symbols from a last symbol of a first PDCCH reception in a BFR search space set where a UE detects a DCI format with CRC scrambled by C-RNTI or MCS-C-RNTI, the UE assumes same antenna port quasi-collocation parameters as the selected candidate reference signal resource for PDCCH monitoring in a CORESET with index 0.

In some implementations, if the UE selected two candidate reference signal resources from two candidate reference signal resource set with different beam failure indices, respectively, the UE assumes the same antenna port quasi-collocation parameters as the two selected candidate reference signal resources for PDCCH monitoring in a CORESET with index 0. In some implementations, the two selected candidate reference signal resources may correspond to two DMRS ports/or two frequency resources/or two time domain resources of CORESET with index 0. In some implementations, if CORESET with index 0 has only one QCL-RSs or only one TCI states and the UE selects two candidate reference signal resources, the UE selects one beam failure index, and the UE assumes the QCL-RS or TCI state of the CORESET with index 0 as the selected candidate reference signal resources with the selected beam failure index for PDCCH monitoring in a CORESET with index 0.

In some implementations, if CORESET with index 0 has two QCL-RSs or two TCI states, and the UE only selected one candidate reference signal resource, the UE assumes one of the QCL-RS or TCI state of the CORESET with index 0 as the one selected candidate reference signal resources for PDCCH monitoring in a CORESET with index 0, the another of QCL-RSs TCI states of the CORESET with index 0 is not changed. The UE will determine the beam failure index for QCL-RS or TCI state of the CORESET with index 0.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, the method performed by a wireless communication device and comprising:
determining an occurrence of a beam failure based on monitoring a detecting reference signal resource set;
reporting a beam failure index, wherein the beam failure index corresponds to the detecting reference signal resource set ; and
sending a medium access control control element (MAC-CE) including the beam failure index.

2. The wireless communication method of claim 1, wherein the MAC-CE includes a plurality of entries of beam failure information, which correspond to one serving cell.

3. The wireless communication method of claim 1, wherein the MAC-CE includes a plurality of entries of beam failure information that correspond to one serving cell, and wherein each of the plurality of entries is associated with a respective beam failure index.

4. The wireless communication method of claim 1, wherein the MAC-CE includes a plurality of groups of octets, which all of the plurality of groups of octets correspond to a same group of serving cell indices, and wherein the plurality of groups of octets correspond to different beam failure indices, respectively.

5. The wireless communication method of claim 4, wherein the MAC-CE includes a plurality of entries of beam failure information, and wherein an order of the entries is first arranged in an ascending order based on the serving cell indices, and then in an ascending order based on the beam failure indices of the plurality of groups of octets.

6. The wireless communication method of claim 1, wherein the MAC-CE includes a plurality of entries of beam failure information, wherein each entry indicates:
that there is no selected candidate reference signal resource for the serving cell index, or
that there is a selected candidate reference signal resource for the serving cell index, and an index of the selected candidate reference signal resource.

7. The wireless communication method of claim 1, wherein the beam failure index further corresponds to at least one of:
a candidate reference signal resource set, a selected candidate reference signal resource, or a serving cell index.

8. The wireless communication method of claim 1, wherein the beam failure index comprises at least one of: an index of the detecting reference signal set, or an index to distinguish multiple detecting reference resource set for a bandwidth part (BWP).

9. The wireless communication method of claim 1, further comprising:
selecting a candidate reference signal resource from a candidate reference signal resource set, wherein the candidate reference signal resource set corresponds to the detecting reference signal resource set, and
wherein the candidate reference signal resource set and the detecting reference signal resource set are associated with a same beam failure index.

10. The wireless communication method of claim 1, further comprising determining a corresponding relationship between P detecting reference signal resource sets and P candidate reference signal resource sets,
wherein P is an integer larger than 1, and the P detecting reference signal resource sets and the P candidate reference signal resource sets correspond to a same bandwidth part (BWP).

11. The wireless communication method of claim 1, further comprising:
determining an occurrence of a beam failure based on monitoring a detecting reference signal resource set;
selecting a candidate reference signal resource from a candidate reference signal resource set; and
determining, according to the selected candidate reference signal resource, a parameter associated with a set of channels,
wherein the candidate reference signal resource set and the set of channels are associated with a same beam failure index.

12. The wireless communication method of claim 11, wherein the set of channels comprise one or more control resource sets (CORESETs), and
a Quasi-Co-Located-Reference-Signal (QCL-RS) of the one or more CORESETs is obtained according to the selected candidate reference signal resource.

13. A wireless communication method, the method performed by a wireless communication node and comprising:
receiving a beam failure index, wherein the beam failure index corresponds to a detecting reference signal resource set, and wherein an occurrence of a beam failure is determined based on monitoring a detecting reference signal resource set; and
receiving a medium access control control element (MAC-CE) including the beam failure index.

14. A wireless communication node, comprising:
at least one processor configured to:
receive, via a receiver, a beam failure index, wherein the beam failure index corresponds to a detecting reference signal resource set, and wherein an occurrence of a beam failure is determined based on monitoring a detecting reference signal resource set; and
receive, via the receiver, a medium access control control element (MAC-CE) including the beam failure index.

15. A wireless communication device, comprising:
at least one processor configured to:
determine an occurrence of a beam failure based on monitoring a detecting reference signal resource set;
reporting a beam failure index, wherein the beam failure index corresponds to the detecting reference signal resource set ; and
sending a medium access control control element (MAC-CE) including the beam failure index.

16. The wireless communication device of claim 15, wherein the MAC-CE includes a plurality of entries of beam failure information, which correspond to one serving cell.

17. The wireless communication device of claim 15, wherein the MAC-CE includes a plurality of entries of beam failure information that correspond to one serving cell, and wherein each of the plurality of entries is associated with a respective beam failure index.

18. The wireless communication device of claim 15, wherein the MAC-CE includes a plurality of groups of octets, which all of the plurality of groups of octets correspond to a same group of serving cell indices, and wherein the plurality of groups of octets correspond to different beam failure indices, respectively.

19. The wireless communication device of claim 18, wherein the MAC-CE includes a plurality of entries of beam failure information, and wherein an order of the entries is first arranged in an ascending order based on the serving cell indices, and then in an ascending order based on the beam failure indices of the plurality of groups of octets.

20. The wireless communication device of claim 15, wherein the beam failure index further corresponds to at least one of:
a candidate reference signal resource set, a selected candidate reference signal resource, or a serving cell index.
